(19) United States
(12) Patent Application Publication
(10) Pub. No.: US 2026/0089610 A1
(43) Pub. Date: Mar. 26, 2026

(54) CONFIGURING SI WINDOWS FOR SI MESSAGE TRANSMISSION AND RECEPTION

(71) Applicant: Samsung Electronics Co., Ltd., Suwon-si (KR)

(72) Inventor: Anil Agiwal, McKinney, TX (US)

(21) Appl. No.: 19/243,358

(22) Filed: Jun. 19, 2025

Related U.S. Application Data
(60) Provisional application No. 63/697,919, filed on Sep. 23, 2024.
(60) Provisional application No. 63/704,292, filed on Oct. 7, 2024.

(51) Int. Cl. H04W 48/12

(52) U.S. Cl. CPC H04W 48/12

(57) ABSTRACT

A user equipment (UE) includes a transceiver configured to receive, from a base station (BS), a plurality of physical downlink control channel (PDCCH) configurations for receiving system information (SI). The UE also includes a processor operably coupled to the transceiver. The processor is configured to identify a PDCCH configuration, from the plurality of PDCCH configurations, associated with an SI message, and monitor a PDCCH for the SI message based on the identified PDCCH configuration.

### CROSS-REFERENCE TO RELATED APPLICATIONS AND CLAIM OF PRIORITY

This application claims priority under 35 U.S.C. § 119 (e) to U.S. Provisional Patent Application No. 63/697,919 filed on Sep. 23, 2024, and U.S. Provisional Patent Application No. 63/704,292 filed on Oct. 7, 2024. The above-identified provisional patent applications are hereby incorporated by reference in their entirety.

### TECHNICAL FIELD

This disclosure relates generally to wireless networks. More specifically, this disclosure relates to configuring system information (SI) windows for SI message transmission and reception.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for configuring system SI windows for SI message transmission and reception.

In one embodiment, a user equipment (UE) is provided. The UE includes a transceiver configured to receive, from a base station (BS), a plurality of physical downlink control channel (PDCCH) configurations for receiving SI. The UE also includes a processor operably coupled to the transceiver. The processor is configured to identify a PDCCH configuration, from the plurality of PDCCH configurations, associated with an SI message, and monitor a PDCCH for the SI message based on the identified PDCCH configuration.

In another embodiment, a BS is provided. The BS includes a transceiver configured to transmit, to a UE, a plurality of PDCCH configurations for receiving SI. The BS also includes a processor operably coupled to the transceiver. The processor is configured to identify a PDCCH configuration, from the plurality of PDCCH configurations, associated with an SI message, and cause the transceiver to transmit the SI message based on the identified PDCCH configuration.

In yet another embodiment, a method of operating a UE is provided. The method includes receiving, BS, a plurality of PDCCH configurations for receiving SI. The method also includes identifying a PDCCH configuration, from the plurality of PDCCH configurations, associated with an SI message, and monitoring a PDCCH for the SI message based on the identified PDCCH configuration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of time multiplexed SI windows according to embodiments of the present disclosure;

FIG. 5 illustrates an example procedure for acquiring an SI message according to embodiments of the present disclosure;

FIG. 6 illustrates an example of SI window and PDCCH monitoring occasions for various SI messages according to embodiments of the present disclosure;

FIG. 7 illustrates another example procedure for acquiring an SI message according to embodiments of the present disclosure;

FIG. 8 illustrates another example of SI window and PDCCH monitoring occasions for various SI messages according to embodiments of the present disclosure;

FIG. 9 illustrates another example procedure for acquiring an SI message according to embodiments of the present disclosure;

FIG. 10 illustrates another example procedure for acquiring an SI message according to embodiments of the present disclosure;

FIG. 11 illustrates an example method for configuring SI windows for SI message transmission and reception according to embodiments of the present disclosure; and

FIG. 12 illustrates another example method for configuring SI windows for SI message transmission and reception according to embodiments of the present disclosure.

### DETAILED DESCRIPTION

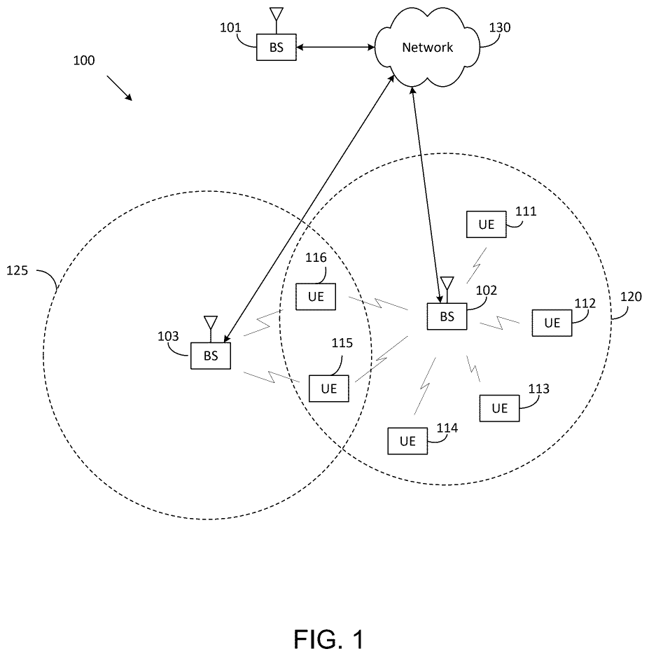

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for configuring system SI windows for SI message transmission and reception. In certain embodiments, one or more of the gNBs 101-103 includes circuitry, programing, or a combination thereof, to support configuring system SI windows for SI message transmission and reception in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

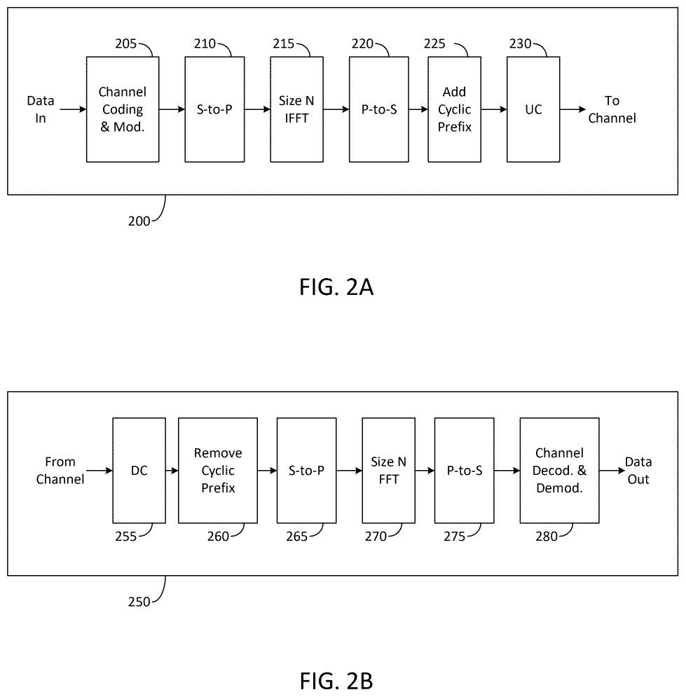

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support configuring system SI windows for SI message transmission and reception as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

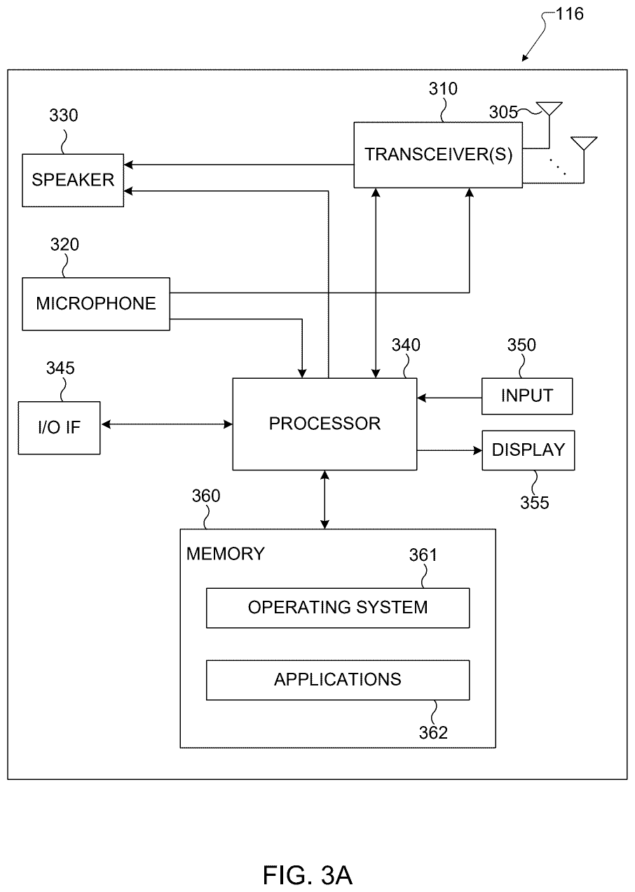

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for configuring system SI windows for SI message transmission and reception as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support configuring system SI windows for SI message transmission and reception as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-Inactivity Timer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in an RRC CONNECTED state. Several types of RA procedures are supported, such as contention based random access, and contention free random access. Each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

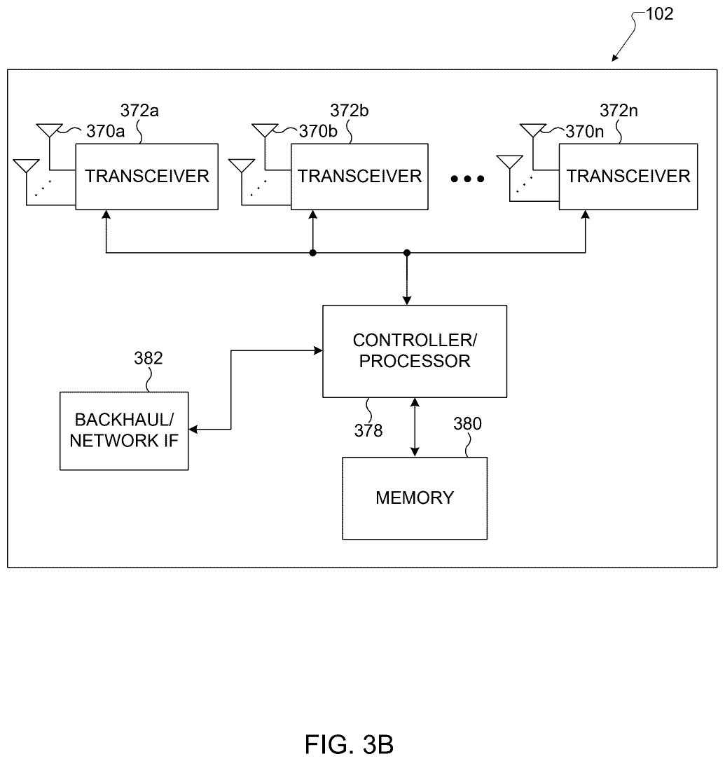

In the next generation wireless communication system (e.g., 5G, beyond 5G, 6G), SI messages may be transmitted in time multiplexed SI windows as shown in FIG. 4.

FIG. 4 illustrates an example of time multiplexed SI windows 400 according to embodiments of the present disclosure. The embodiment of time multiplexed SI windows of FIG. 4 is for illustration only. Different embodiments of time multiplexed SI windows could be used without departing from the scope of this disclosure.

In the example of FIG. 4, SI messages 1, 2, and 3 are time multiplexed in respective windows that occur once every 80 ms. SI message 1 is transmitted first within a first window. Next, SI message 2 is transmitted within a second window. SI message 3 is transmitted last within a third window.

Although FIG. 4 illustrates one example of time multiplexed SI windows 400, various changes may be made to FIG. 4. For example, various changes to the window size, the number of SI messages in the window, etc., could be made, according to particular needs.

In time multiplexed SI windows such as shown in FIG. 4, each SI message is mapped to an SI window. The SI window of each SI message is different (i.e., multiple SI messages are not transmitted in the same SI window). Time multiplexed SI windows and one to one mapping between SI messages and SI windows results in more wakeup time for the network to transmit the SI messages, resulting in more energy consumption. Time multiplexed SI windows (for example, due to one-to-one mapping between SI messages and SI windows) may also result in more delay in transmitting the SI message upon receiving a request for transmission. Various embodiments of the present disclosure provide for transmission of SI messages with reduced wakeup time and delay.

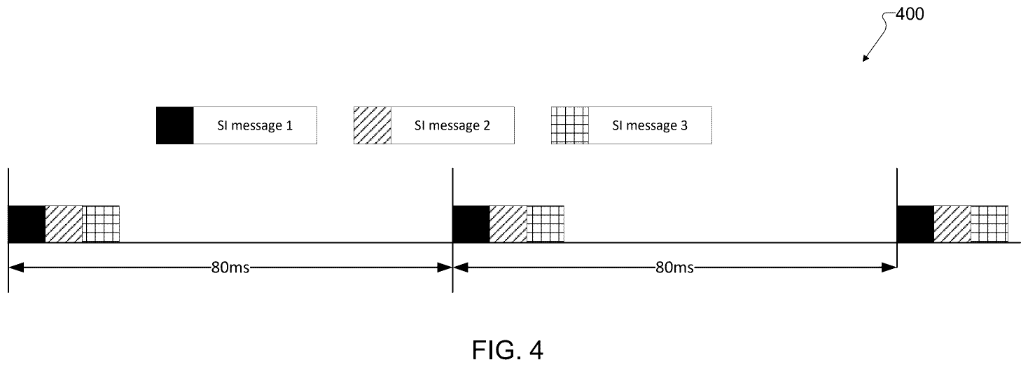

FIG. 5 illustrates an example procedure 500 for acquiring an SI message according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 5, procedure 500 begins at operation 510. At operation 510, a UE (such as UE 116 of FIG. 1) receives, from a base station (e.g., a gNB of a camped cell/SpCell) scheduling information (e.g., an SI periodicity) of SI messages, a plurality of SearchSpaces for receiving other system information (OSI) or SI messages, si-WindowLength, SI window # or SI window position associated with each SI message, and a SearchSpace # associated with each SI message. In some embodiments, this information can be received in an RRC message or SIB1.

In some embodiments, the plurality of SearchSpaces for receiving OSI or SI messages can be a list of search space identifiers, where each search space identifier uniquely identifies a search space configuration amongst multiple search space configurations. The search space configuration indicates time domain locations (e.g., one or more slots in which PDCCH monitoring occasion[s] are located, a starting OFDM symbol of a PDCCH monitoring occasion in a slot, length [in number of OFDM symbols] of a PDCCH monitoring occasion in the slot) of PDCCH monitoring occasions. The search space configuration also indicates frequency domain resources (e.g., starting PRB index, number of PRBs) of each PDCCH monitoring occasion.

A plurality of SearchSpaces for receiving other system information (OSI) or SI messages provides the advantage that the network can transmit PDCCH for multiple SI messages concurrently using different resources in the frequency domain (i.e., frequency division multiplexing). For example, the network can map SI message 1 to the first search space for OSI, and the network can map SI message 2 to the second search space for OSI. Search space 1 and search space 2 can configure different frequency domain resources (e.g., starting PRB index, number of PRBs) of each PDCCH monitoring occasion and search space 1 and search space 2 can configure the same time domain resources. This can reduce the network wake up time to transmit both SI message 1 and SI message 2.

At operation 520, to acquire an SI message, the UE determines the integer value x=(si-WindowPosition−1)×w, where w is the si-Window Length.

At operation 530, to acquire an SI message, the UE then determines the start of the SI-window. The SI-window starts at the slot #a, where a=x mod N, in the radio frame for which SFN mod T=FLOOR (x/N), where Tis the si-Periodicity of the concerned SI message and N is the number of slots in a radio frame. The number of slots in a radio frame depends on sub carrier spacing, and mapping between the number of slots in the radio frame and the sub carrier spacing can be pre-defined. The sub carrier spacing for OSI can be configured, or the sub carrier spacing for OSI is the SCS of the BWP in which the UE receives the OSI/SI message.

At operation 540, in the determined SI window, the UE identifies the PDCCH monitoring occasions for receiving a PDCCH addressed to an SI-RNTI based on the SearchSpace associated with the SI message amongst the plurality of searchSpaces for OSI. The SearchSpace associated with the SI message can be indicated by signaling a search space identifier for each SI message or a plurality of searchSpaces for OSI can be sequentially indexed (e.g., in the order in which they are signaled in a list of searchSpaces for OSI) and this index can be indicated for each SI message.

At operation 550, the UE then monitors one or more PDCCH monitoring occasions amongst the identified PDCCH monitoring occasions.

At operation 560, the UE receives a PDCCH addressed to the SI-RNTI in the monitored PDCCH monitoring occasion.

At operation 570, the UE receives a TB including an SI message based on the information in received the PDCCH.

In some embodiments, in the procedure 500, the SI message can be a SIB.

In some embodiments, instead of multiple search spaces for OSI, search spaces for OSI can be common but a list of CORESETs can be configured, wherein each SI message can be associated with one CORESET in the list of CORESETs. By having different frequency domain resources in different CORESETs, SI windows can be frequency division multiplexed (FDMed) for energy savings at the base station.

Although FIG. 5 illustrates one example procedure 500 for acquiring an SI message, various changes may be made to FIG. 5. For example, while shown as a series of operations, various operations in FIG. 5 could overlap, occur in parallel, occur in a different order, occur any number of times, be omitted, or be replaced by other operations.

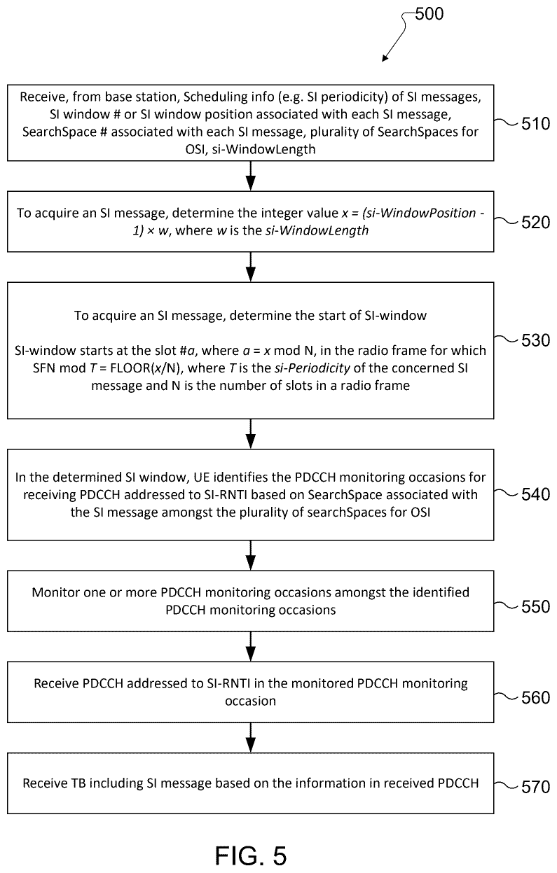

FIG. 6 illustrates an example 600 of SI window and PDCCH monitoring occasions for various SI messages according to embodiments of the present disclosure. The embodiment of SI window and PDCCH monitoring occasions for various SI messages of FIG. 6 is for illustration only. Different embodiments of SI window and PDCCH monitoring occasions for various SI messages could be used without departing from the scope of this disclosure.

FIG. 6 is an example illustration of SI window and PDCCH monitoring occasions for various SI messages according to procedure 500 of FIG. 5. In FIG. 6, PDCCH monitoring occasions for SI messages 1, 2, and 3 are frequency division multiplexed within the same SI window. The window occurs once every 80 ms. The PDCCH monitoring occasions for SI messages 1, 2, and 3 are repeated several times within the window. The time and frequency locations of the PDCCH monitoring occasions may be indicated by associated search spaces as described regarding procedure 500 of FIG. 5.

Although FIG. 6 illustrates one example 600 of SI window and PDCCH monitoring occasions for various SI messages, various changes may be made to FIG. 6. For example, various changes to SI window length, etc. could be made according to particular needs.

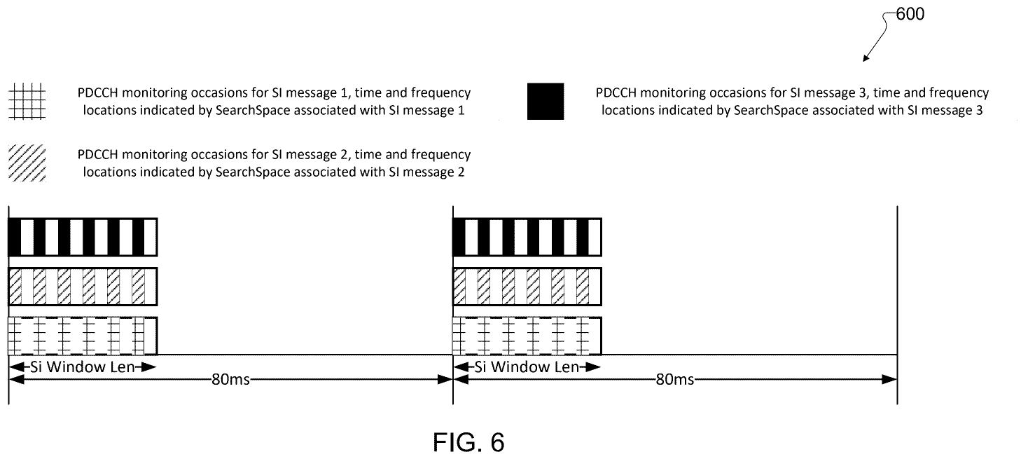

FIG. 7 illustrates another example procedure 700 for acquiring an SI message according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 7, procedure 700 begins at operation 710. At operation 710, a UE (such as UE 116 of FIG. 1) receives, from a base station (e.g., a gNB of a camped cell/SpCell) scheduling information (e.g., an SI periodicity) of SI messages, a SearchSpace for receiving other OSI or SI messages, si-WindowLength, SI window # or SI window position associated with each SI message, and a frequency domain resource index associated with each SI message. In some embodiments, this information can be received in an RRC message or SIB1.

In some embodiments, the SearchSpace for receiving OSI or SI messages can be a search space identifier, where the search space identifier uniquely identifies a search space configuration amongst multiple search space configurations. The Search space configuration indicates time domain locations (e.g., one or more slots in which PDCCH monitoring occasion(s) are located, a starting OFDM symbol of PDCCH monitoring occasions in a slot, a length (in number of OFDM symbols) of a PDCCH monitoring occasion in the slot) of PDCCH monitoring occasions. The search space configuration also indicates a list of frequency domain resources (e.g., a starting PRB index, number of PRBs). Each of these frequency domain resources can be identified by a frequency domain resource index (either explicitly by signaling this index in each entry of a list of frequency domain resources or implicitly by logically indexing each entry in a list of frequency domain resources).

At operation 720, to acquire an SI message, the UE determines the integer value x=(si-WindowPosition−1)×w, where w is the si-Window Length.

At operation 730, to acquire an SI message, the UE then determines the start of the SI-window. The SI-window starts at the slot #a, where a=x mod N, in the radio frame for which SFN mod T=FLOOR (x/N), where Tis the si-Periodicity of the concerned SI message and N is the number of slots in a radio frame. The number of slots in a radio frame depends on sub carrier spacing, and mapping between the number of slots in a radio frame and sub carrier spacing can be pre-defined. The sub carrier spacing for OSI can be configured, or the sub carrier spacing for OSI is the SCS of the BWP in which the UE receives an OSI/SI message.

At operation 740, in the determined SI window, the UE identifies the PDCCH monitoring occasions for receiving a PDCCH addressed to an SI-RNTI based on the searchSpace for OSI and a frequency domain resource index associated with the SI message. Slots and symbols of each PDCCH monitoring occasion are the same for all SI messages, but the frequency domain resources for each SI message are identified based on an associated frequency domain resource index.

At operation 750, the UE then monitors one or more PDCCH monitoring occasions based on identified time and frequency domain resources of PDCCH monitoring occasions.

At operation 760, the UE receives a PDCCH addressed to an SI-RNTI in the monitored PDCCH monitoring occasion.

At operation 770, the UE receives a TB including an SI message based on the information in received the PDCCH.

In some embodiments, in procedure 700 the SI message can be a SIB.

Although FIG. 7 illustrates one example procedure 700 for acquiring an SI message, various changes may be made to FIG. 7. For example, while shown as a series of operations, various operations in FIG. 7 could overlap, occur in parallel, occur in a different order, occur any number of times, be omitted, or be replaced by other operations.

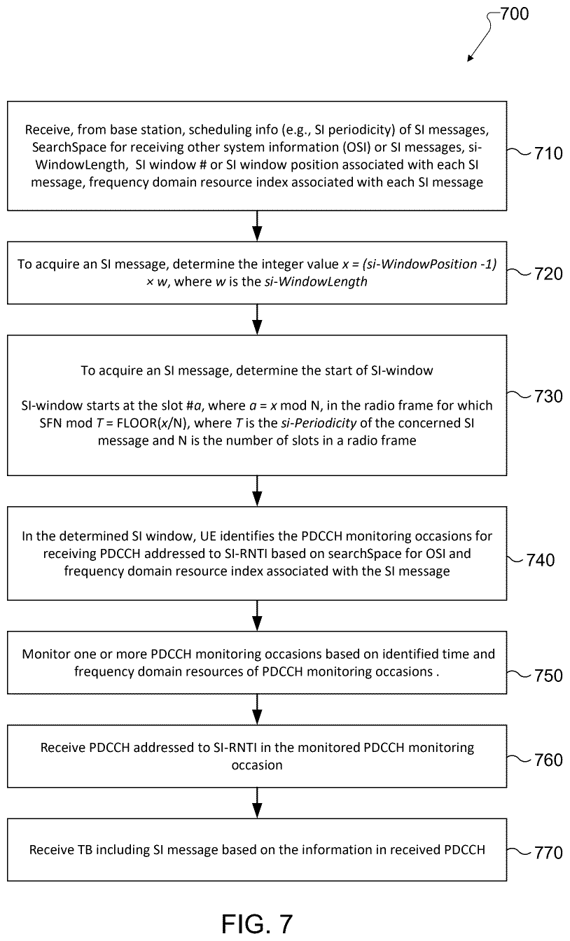

FIG. 8 illustrates another example 800 of SI window and PDCCH monitoring occasions for various SI messages according to embodiments of the present disclosure. The embodiment of SI window and PDCCH monitoring occasions for various SI messages of FIG. 8 is for illustration only. Different embodiments of SI window and PDCCH monitoring occasions for various SI messages could be used without departing from the scope of this disclosure.

FIG. 8 is an example illustration of SI window and PDCCH monitoring occasions for various SI messages according to procedure 700 of FIG. 7. In FIG. 8, PDCCH monitoring occasions for SI messages 1, 2, and 3 are frequency division multiplexed within the same SI window. The window occurs once every 80 ms. The PDCCH monitoring occasions for SI messages 1, 2, and 3 are repeated several times within the window. The time locations of the PDCCH monitoring occasions may be indicated by a search space for OSI as described regarding procedure 700 of FIG. 7. The frequency locations may be indicated by associated indexes as described regarding procedure 700 of FIG. 7.

Although FIG. 8 illustrates one example 800 of SI window and PDCCH monitoring occasions for various SI messages, various changes may be made to FIG. 8. For example, various changes to SI window length, etc. could be made according to particular needs.

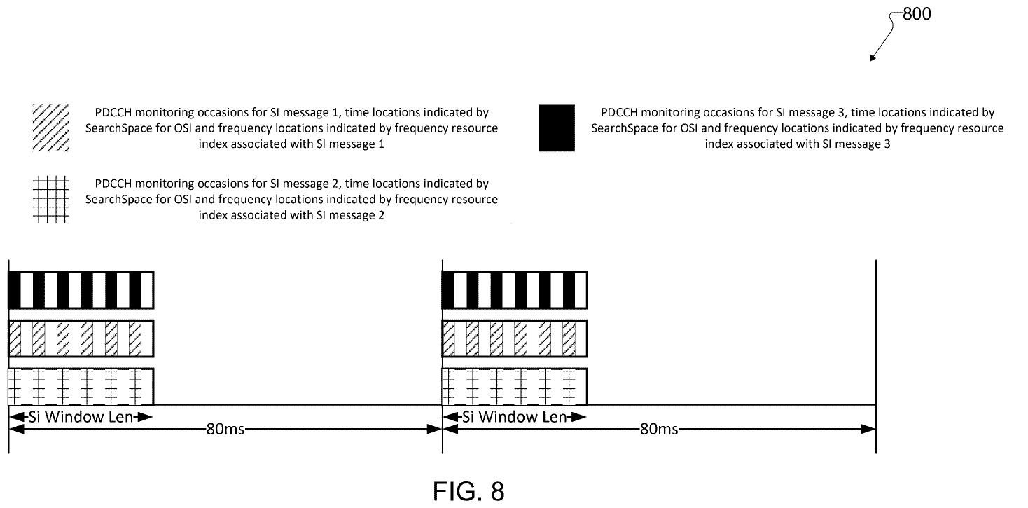

FIG. 9 illustrates another example procedure 900 for acquiring an SI message according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 9, procedure 900 begins at operation 910. At operation 910, a UE 902 (which may be similar or identical to UE 116 of FIG. 1) receives scheduling information of SIB(s) supported in a cell from a 6G nodeB (NB) 904 of the cell. This information may be received in an RRC message or SIB1 or primary/secondary SIB1 (in cases where the cell supports multiple SIB1s) or any other signaling message. This scheduling information includes a list of SI messages supported in the cell, a list of one or more SIBs associated with each SI message, a periodicity of each SI message, length of an SI-window (si-Window Length, this can be common or can be separate for each SI message), an SI window/position (si-WindowPosition) associated with each SI message or association between SI messages and SI windows, wherein each SI window can be associated with one or more SI messages.

At operation 915, to acquire an SI message, UE 902 determines the integer value x=(si-WindowPosition−1)×w, where w is the si-WindowLength. Then UE 902 UE determines the start of the SI-window. The SI-window starts at the slot #a, where a=x mod N, in the radio frame for which SFN mod T=FLOOR (x/N), where Tis the si-Periodicity of the concerned SI message and N is the number of slots in a radio frame. The Number of slots in a radio frame depends on the sub carrier spacing, and the mapping between the number of slots in a radio frame and sub carrier spacing can be pre-defined. The sub carrier spacing for OSI can be configured or the sub carrier spacing for OSI is the SCS of the DL BWP in which the UE receives the OSI/SI message. The DL BWP can be the initial DL BWP or the active DL BWP.

At operation 920, UE 902 monitors a PDCCH addressed to an SI-RNTI in PDCCH monitoring occasions (PMOs) of the determined SI window.

At operation 925, UE 902 receives a PDCCH addressed to the SI-RNTI in the monitored PDCCH monitoring occasion. The UE 902 determines the SI window is associated with multiple SI messages. The DCI of the received PDCCH schedules multiple TBs, wherein each TB includes an SI message (or alternately one or more SI messages). The DCI indicates the following for each TB:
a. Frequency domain resource
b. Time domain resource
c. MCS
d. redundancy version

In some embodiments, the MCS can be common (e.g., not separately signaled) for all TBs. In some embodiments, a redundancy version can be common (e.g., not separately signaled) for all TBs. In some embodiments, the frequency domain resource can be common (e.g., not separately signaled) for all TBs.

The DCI may also indicate which TB includes which SI message (or SI messages). There can be several ways in which this can be indicated.

In some embodiments, SI messages supported in the cell can be sequentially indexed in the order in which they are listed in the list of SI messages received in operation 910. This index can be informed in the DCI (received in operation 925) for each TB scheduled by the DCI. This index of SI message can then be used to identify the TB associated with the SI message amongst the multiple TBs scheduled by the DCI (received in operation 925).

Alternately, in some embodiments, SI messages supported in the cell can be sequentially indexed in the order in which they are listed in the list of SI messages received in operation 910. The SI messages associated with an SI window are then numbered in the ascending order of this index. For example, assume a list of SI messages received in operation 910 includes four SI messages. The SI messages are indexed sequentially in the order in which the SI messages appear in the list, the index of first SI message is 1, the index of second SI message is 2, the index of third SI message is 3 and the index of fourth SI message is 4.

The SI message with index 2 and the SI message with index 3 are mapped to SI window 1. For the SI window 1, the SI message with index 2 is numbered 1 and the SI message with index 3 is numbered 2 in ascending order of the index. Alternately, for SI window 1, the SI message with index 2 is numbered 0 and the SI message with index 3 is numbered 1 in ascending order of the index.

The SI message with index 1 and the SI message with index 4 are mapped to SI window 2. For SI window 2, the SI message with index 1 is numbered 1 and the SI message with index 4 is numbered 2. Alternately, for SI window 2, the SI message with index 1 is numbered 0 and SI message with index 4 is numbered 1.

This number assigned to an SI message can be informed in the DCI (received in operation 925) for each TB scheduled by the DCI. This number assigned to the SI message can then be used to identify the TB associated with the SI message amongst the multiple TBs scheduled by the DCI (received in operation 925).

Alternately, in some embodiments, each SI message supported in the cell can be assigned a unique identifier in the list of SI messages received in step 910. This identifier can be informed in the DCI (received in operation 925) for each TB scheduled by the DCI. This identifier assigned to the SI message can then be used to identify the TB associated with the SI message amongst the multiple TBs scheduled by the DCI (received in operation 925).

At operation 930, UE 902 determines the information of the TB associated with an SI message which the UE needs to acquire from a plurality of TBs scheduled by the DCI of received PDCCH.

At operation 935, UE 902 receives the TB based on the determined information.

At operation 940, UE 902 decodes the TB and obtains the SI message from the decoded TB.

Alternately, in some embodiments, UE 902 determines the start of the SI-window at operation 915 as follows: SI-window starts at the start of the radio frame for which SFN mod T=0 (or SFN mod T=offset), where Tis the si-Periodicity of the concerned SIB.

Alternately, in some embodiments, UE 902 determines the start of the SI-window at operation 915 as follows: SI-window starts at start at subframe number of SFN which satisfies:

$$[ ( SFN \times 10 ) + subframe number ] modulo ( T ) = 0 OR [ ( SFN \times 10 ) + subframe number ] modulo ( T ) = offset .$$

Although FIG. 9 illustrates one example procedure 900 for acquiring an SI message, various changes may be made to FIG. 9. For example, while shown as a series of operations, various operations in FIG. 9 could overlap, occur in parallel, occur in a different order, occur any number of times, be omitted, or be replaced by other operations.

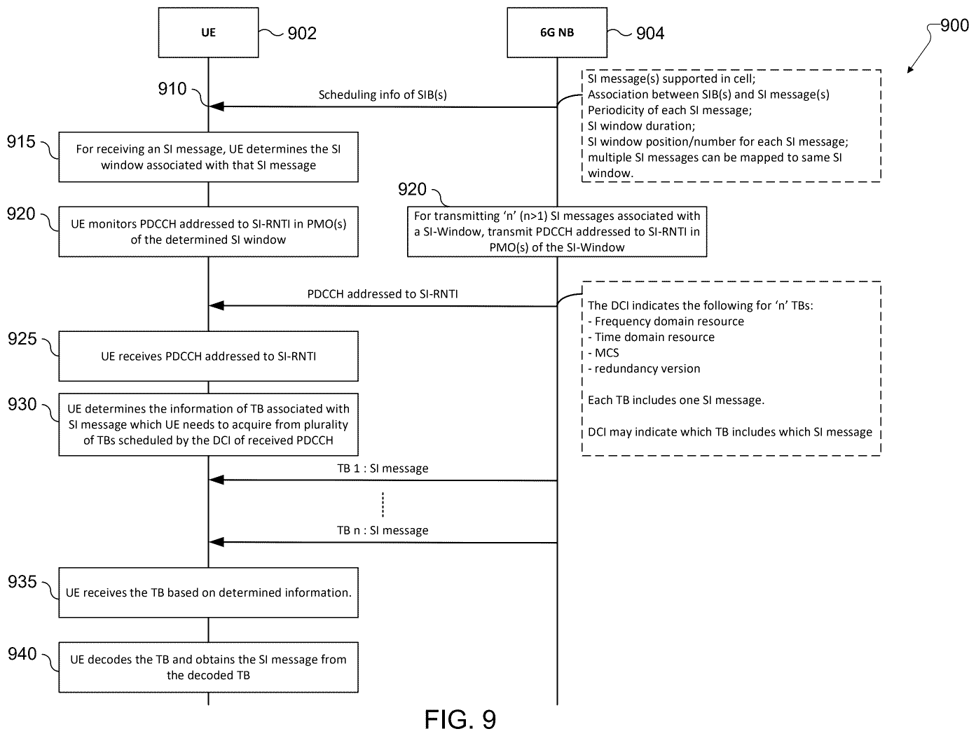

FIG. 10 illustrates another example procedure 1000 for acquiring an SI message according to embodiments of the present disclosure. An embodiment of the procedure illustrated in FIG. 1000 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for acquiring an SI message could be used without departing from the scope of this disclosure.

In the example of FIG. 10, procedure 1000 begins at operation 1010. At operation 1010, a UE 1002 (which may be similar or identical to UE 116 of FIG. 1) receives scheduling information of SIB(s) supported in a cell from a 6G NB 1004 of the cell. This information may be received in an RRC message or SIB1 or primary/secondary SIB1 (in cases where the cell supports multiple SIB1s) or any other signaling message. This scheduling information includes a list of SIBs supported in the cell, a periodicity of each SIB, length of an SI-window (si-Window Length, this can be common or can be separate for each SIB), an SI window/position (si-WindowPosition) associated with each SIB or association between SIBs and SI windows wherein each SI window can be associated with one or more SIBs.

At operation 1015, for acquiring a SIB, UE 1002 determines the integer value x=(si-Window Position−1)×w, where w is the si-WindowLength. Then UE 1002 determines the start of the SI-window. The SI-window starts at the slot #a, where a=x mod N, in the radio frame for which SFN mod T=FLOOR (x/N), where Tis the si-Periodicity of the concerned SIB and N is the number of slots in a radio frame. The number of slots in a radio frame depends on sub carrier spacing, and mapping between the number of slots in a radio frame and the sub carrier spacing can be pre-defined. The sub carrier spacing for OSI can be configured or the sub carrier spacing for OSI is the SCS of DL BWP in which the UE 1002 receives the OSI/SI message. The DL BWP can be the initial DL BWP or the active DL BWP.

At operation 1020, UE 1002 monitors a PDCCH addressed to an SI-RNTI in PDCCH monitoring occasions (PMOs) of the determined SI window.

At operation 1025, UE 1002 receives a PDCCH addressed to the SI-RNTI in the monitored PDCCH monitoring occasion. The UE 1002 determines the SI window is associated with multiple SIBs. The DCI of the received PDCCH schedules multiple TBs wherein each TB includes one or more SIBs. The DCI indicates the following for each TB:
a. Frequency domain resource
b. Time domain resource
c. MCS
d. redundancy version

In some embodiments, the MCS can be common (e.g., not separately signaled) for all TBs. In some embodiments, the redundancy version can be common (e.g., not separately signaled) for all TBs. In some embodiments, the frequency domain resource can be common (e.g., not separately signaled) for all TBs.

The DCI may also indicate which TB includes which SIB(s). There can be several ways in which this can be indicated.

In some embodiments, the SIBs supported in the cell can be sequentially indexed in the order in which they are listed in the list of SIBs received in operation 1010. This index(s) can be informed in the DCI (received in operation 1025) for each TB scheduled by the DCI. This index assigned to the SIB can then be used to identify the TB associated with the SIB amongst the multiple TBs scheduled by the DCI (received in operation 1025).

Alternately, in some embodiments, the SIBs supported in the cell can be sequentially indexed in the order in which they are listed in the list of SIBs received in operation 1010. The SIBs associated with an SI window are then numbered in the ascending order of this index. For example, assume the list of SIBs received in step 1 includes four SIBs. They are indexed sequentially in the order in which they appear in the list, the index of first SIB is 1, the index of the second SIB is 2, the index of the third SIB is 3, and the index of the fourth SIB is 4.

The SIB with index 2 and the SIB with index 3 are mapped to SI window 1. For SI window 1, the SIB with index 2 is numbered 1 and the SIB with index 3 is numbered 2 in ascending order of the index. Alternately, for SI window 1, the SIB with index 2 is numbered 0 and the SIB with index 3 is numbered 1 in ascending order of the index.

The SIB with index 1 and the SIB with index 4 are mapped to SI window 2. For SI window 2, if the SIB with index 1 is numbered 1 and the SIB with index 4 is numbered 2. Alternately, for SI window 2, the SIB with index 1 is numbered 0 and the SIB with index 4 is numbered 1.

This number assigned to the SIB can be informed in the DCI (received in step 1025) for each TB scheduled by the DCI. This number assigned to the SIB can then be used to identify the TB associated with the SIB amongst the multiple TBs scheduled by the DCI (received in step 1025).

In some embodiments, each SIB supported in the cell can be assigned a unique identifier in the list of SIBs received in step 1010. The identity of each SIB can be pre-defined. This identifier can be informed in the DCI (received in step 1025) for each TB scheduled by the DCI. This identifier assigned to the SIB can then be used to identify the TB associated with the SIB amongst the multiple TBs scheduled by the DCI (received in step 1025).

At operation 1030, UE 1002 determines the information of TB associated with the SIB which UE 1002 needs to acquire from the plurality of TBs scheduled by the DCI of the received PDCCH.

At operation 1035, UE 1002 receives the TB based on the determined information.

At operation 1040, UE 1002 decodes the TB and obtains the SIB from the decoded TB.

Alternately, in some embodiments, UE 1002 determines the start of the SI-window at operation 1015 as follows: SI-window starts at start of the radio frame for which SFN mod T=0 (or SFN mod T=offset), where Tis the si-Periodicity of the concerned SIB.

Alternately, in some embodiments, UE 1002 determines the start of SI-window at operation 10150 as follows: SI-window starts at start at subframe number of SFN which satisfy:

$$[ ( SFN \times 10 ) + subframe number ] modulo ( T ) = 0 OR [ ( SFN \times 10 ) + subframe number ] modulo ( T ) = offset .$$

Although FIG. 10 illustrates one example procedure 1000 for acquiring an SI message, various changes may be made to FIG. 10. For example, while shown as a series of operations, various operations in FIG. 10 could overlap, occur in parallel, occur in a different order, occur any number of times, be omitted, or be replaced by other operations.

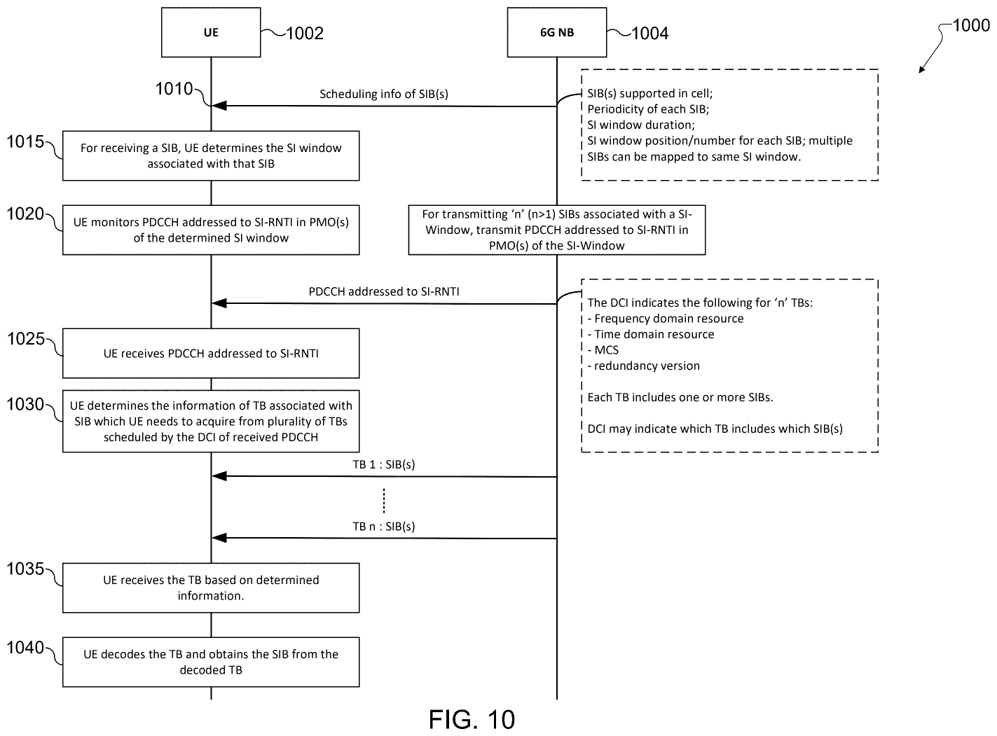

FIG. 11 illustrates an example method 1100 for configuring SI windows for SI message transmission and reception according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for configuring SI windows for SI message transmission and reception could be used without departing from the scope of this disclosure.

In the example of FIG. 11, method 1100 begins at step 1110. At step 1110, a UE (such as UE 116 of FIG. 1) receives, from a BS (such as gNB 102 of FIG. 1), a plurality of PDCCH configurations for receiving SI.

At step 1120, the UE identifies a PDCCH configuration, from the plurality of PDCCH configurations, associated with an SI message.

In some embodiments, to identify the PDCCH configuration, the UE may identify associations between one or more SI messages and the plurality of PDCCH configurations. In some embodiments, the UE may receive the associations between the one or more SI messages and the plurality of PDCCH configurations from the BS. In some embodiments, the one or more SI messages may include at least two or more SI messages, and at least two of the SI messages may be mapped to an identical SI window. In these embodiments, each of the SI messages mapped to the identical SI window may be associated with a different PDCCH configuration of the plurality of PDCCH configurations.

In some embodiments, the PDCCH configuration associated with the SI message may be a search space configuration. In these embodiments, the UE may receive, from the BS, an association between an identity of the search space configuration and the SI message.

In some embodiments, the PDCCH configuration associated with the SI message may be a CORESET configuration. In these embodiments, the UE may receive, from the BS, an association between an identity of the CORESET configuration and the SI message.

In some embodiments, the PDCCH configuration associated with the SI message may be a frequency domain resource configuration. In these embodiments, the UE may receive, from the BS, an association between an identity of the frequency domain resource configuration and the SI message.

At step 1130, the UE monitors a PDCCH for the SI message based on the identified PDCCH configuration.

Although FIG. 11 illustrates one example method 1100 for configuring SI windows for SI message transmission and reception, various changes may be made to FIG. 11. For example, while shown as a series of steps, various steps in FIG. 11 could overlap, occur in parallel, occur in a different order, occur any number of times, be omitted, or replaced by other steps.

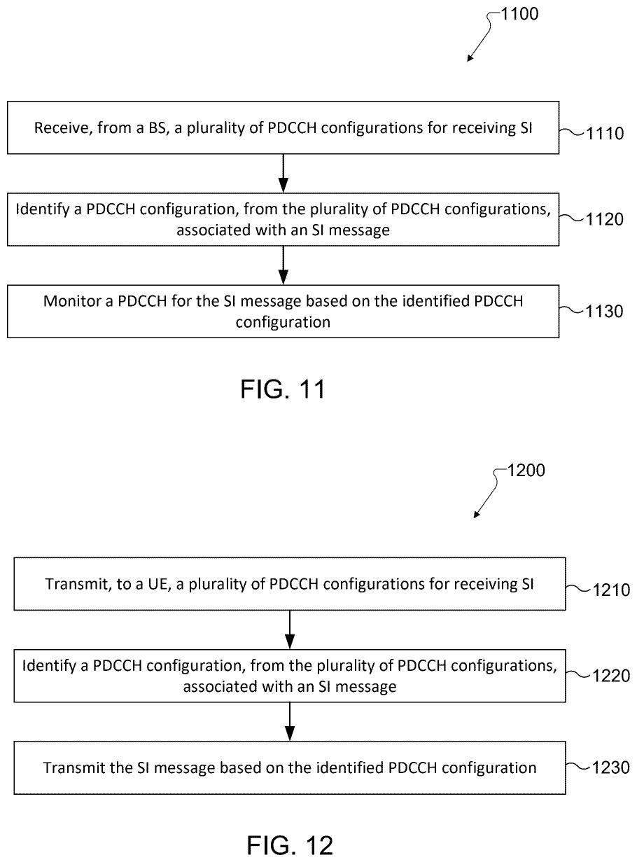

FIG. 12 illustrates another example method 1200 for configuring SI windows for SI message transmission and reception according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for configuring SI windows for SI message transmission and reception could be used without departing from the scope of this disclosure.

In the example of FIG. 12, method 1200 begins at step 1210. At step 1110, a BS (such as gNB 102 of FIG. 1) transmits, to a UE (such as UE 116 of FIG. 1), a plurality of PDCCH configurations for receiving SI.

At step 1220, the BS identifies a PDCCH configuration, from the plurality of PDCCH configurations, associated with an SI message. In some embodiments, the PDCCH configuration associated with the SI message may be a search space configuration. In some embodiments, the PDCCH configuration associated with the SI message may be a CORESET configuration. In some embodiments, the PDCCH configuration associated with the SI message may be a frequency domain resource configuration.

At step 1230, the BS transmits the SI message based on the identified PDCCH configuration.

In some embodiments, before transmitting the SI message, the BS may transmit, to the UE, associations between one or more SI messages and the plurality of PDCCH configurations. In some embodiments, the BS may transmit, to the UE, an association between an identity of a search space configuration and the SI message. In some embodiments, the BS may transmit, to the UE, an association between an identity of a CORESET configuration and the SI message. In some embodiments, the BS may transmit, to the UE, an association between an identity of a frequency domain resource configuration and the SI message.

In some embodiments, the one or more SI messages may include at least two or more SI messages, at least two of the SI messages may be mapped to an identical SI window, and each of the SI messages mapped to the identical SI window may be associated with a different PDCCH configuration of the plurality of PDCCH configurations.

Although FIG. 12 illustrates one example method 1200 for configuring SI windows for SI message transmission and reception, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a base station (BS), a plurality of physical downlink control channel (PDCCH) configurations for receiving system information (SI); and
a processor operably coupled to the transceiver, the processor configured to:
identify a PDCCH configuration, from the plurality of PDCCH configurations, associated with an SI message; and
monitor a PDCCH for the SI message based on the identified PDCCH configuration.

2. The UE of claim 1, wherein to identify the PDCCH configuration, the processor is further configured to identify associations between one or more SI messages and the plurality of PDCCH configurations.

3. The UE of claim 2, wherein the transceiver is further configured to receive, from the BS, the associations between the one or more SI messages and the plurality of PDCCH configurations.

4. The UE of claim 3, wherein:
the one or more SI messages includes at least two or more SI messages;
at least two of the SI messages are mapped to an identical SI window; and
each of the SI messages mapped to the identical SI window are associated with a different PDCCH configuration of the plurality of PDCCH configurations.

5. The UE of claim 1, wherein:
the PDCCH configuration associated with the SI message is a search space configuration; and
the transceiver is further configured to receive, from the BS, an association between an identity of the search space configuration and the SI message.

6. The UE of claim 1, wherein:
the PDCCH configuration associated with the SI message is a control resource set (CORESET) configuration; and
the transceiver is further configured to receive, from the BS, an association between an identity of the CORESET configuration and the SI message.

7. The UE of claim 1, wherein:
the PDCCH configuration associated with the SI message is a frequency domain resource configuration; and
the transceiver is further configured to receive, from the BS, an association between an identity of the frequency domain resource configuration and the SI message.

8. A base station (BS) comprising:
a transceiver configured to transmit, to a user equipment (UE), a plurality of physical downlink control channel (PDCCH) configurations for receiving system information (SI); and
a processor operably coupled to the transceiver, the processor configured to:
identify a PDCCH configuration, from the plurality of PDCCH configurations, associated with an SI message; and
cause the transceiver to transmit the SI message based on the identified PDCCH configuration.

9. The BS of claim 8, wherein the transceiver is further configured to transmit, to the UE, associations between one or more SI messages and the plurality of PDCCH configurations.

10. The BS of claim 9, wherein:
the one or more SI messages includes at least two or more SI messages;
at least two of the SI messages are mapped to an identical SI window; and
each of the SI messages mapped to the identical SI window are associated with a different PDCCH configuration of the plurality of PDCCH configurations.

11. The BS of claim 8, wherein:
the PDCCH configuration associated with the SI message is a search space configuration; and
the transceiver is further configured to transmit, to the UE, an association between an identity of the search space configuration and the SI message.

12. The BS of claim 8, wherein:
the PDCCH configuration associated with the SI message is a control resource set (CORESET) configuration; and
the transceiver is further configured to transmit, to the UE, an association between an identity of the CORESET configuration and the SI message.

13. The BS of claim 8, wherein:
the PDCCH configuration associated with the SI message is a frequency domain resource configuration; and
the transceiver is further configured to transmit, to the UE, an association between an identity of the frequency domain resource configuration and the SI message.

14. A method of operating user equipment (UE), the method comprising:
receiving, from a base station (BS), a plurality of physical downlink control channel (PDCCH) configurations for receiving system information (SI);
identifying a PDCCH configuration, from the plurality of PDCCH configurations, associated with an SI message; and
monitoring a PDCCH for the SI message based on the identified PDCCH configuration.

15. The method of claim 14, wherein to identify the PDCCH configuration, the method further comprises identifying associations between one or more SI messages and the plurality of PDCCH configurations.

16. The method of claim 15, further comprising receiving, from the BS, the associations between the one or more SI messages and the plurality of PDCCH configurations.

17. The method of claim 16, wherein:
the one or more SI messages includes at least two or more SI messages;
at least two of the SI messages are mapped to an identical SI window; and
each of the SI messages mapped to the identical SI window are associated with a different PDCCH configuration of the plurality of PDCCH configurations.

18. The method of claim 14, wherein:
the PDCCH configuration associated with the SI message is a search space configuration; and
the method further comprises receiving, from the BS, an association between an identity of the search space configuration and the SI message.

19. The method of claim 14, wherein:
the PDCCH configuration associated with the SI message is a control resource set (CORESET) configuration; and
the method further comprises receiving, from the BS, an association between an identity of the CORESET configuration and the SI message.

20. The method of claim 14, wherein:
the PDCCH configuration associated with the SI message is a frequency domain resource configuration; and
the method further comprises receiving, from the BS, an association between an identity of the frequency domain resource configuration and the SI message.
